(19) United States
(12) Patent Application Publication
(10) Pub. No.: US 2026/0308017 A1
(43) Pub. Date: Oct. 8, 2026

(54) UTILIZATION OF AN ULTRA-HIGH PRESSURE REVERSE OSMOSIS MEMBRANE SYSTEM TO TREAT INDUSTRIAL WASTEWATER OR A REVERSE OSMOSIS REJECT WASTE STREAM

(71) Applicant: Renovo Resources LLC, Irvine, CA (US)

(72) Inventors: Brad Biagini, Wexford, PA (US); Lnsp Nagghappan, Irvine, CA (US)

(21) Appl. No.: 19/636,575

(22) Filed: Apr. 1, 2026

Related U.S. Application Data
(60) Provisional application No. 63/782,498, filed on Apr. 2, 2025.

(51) Int. Cl. C02F 1/00; B01D 61/02; B01D 61/04; B01D 61/08; B01D 61/12; C02F 1/44; C02F 5/08; C02F 5/10

(52) U.S. Cl. CPC C02F 1/008; B01D 61/026; B01D 61/04; B01D 61/08; B01D 61/12; C02F 1/441; C02F 5/086; C02F 5/10; B01D 2311/04; C02F 2209/03; C02F 2301/08

(57) ABSTRACT

Described is a method of concentrating a high salinity feed stream using an ultra-high pressure reverse osmosis (UHPRO) membrane system. An industrial wastewater or reverse osmosis (RO) reject stream containing dissolved ions is received and, optionally following pretreatment, directed to the UHPRO membrane system. The UHPRO membrane system is operated at an elevated pressure and within a constrained membrane flux range, with chemical conditioning including at least one scale inhibitor and a surfactant, such that pressure, membrane flux, and chemical conditioning are concurrently controlled to enable stable operation at total dissolved solids (TDS) concentrations exceeding 100,000 mg/L. A permeate stream and a concentrate stream are generated, where the concentrate stream is disposed and the permeate stream may be further treated, including by a second pass reverse osmosis system. The treated permeate can be adjusted for pH and remineralized to produce water suitable for beneficial reuse.

### BACKGROUND

Economic feasibility and sustainability goals of industrial wastewater treatment processes are often impacted by maximizing a volume of freshwater generated and minimizing liquid waste volumes that require disposal. Two common desalination methods for treating industrial wastewater to maximize freshwater and minimize liquid waste involve membrane-based treatment with reverse osmosis (RO) or thermal treatment techniques (e.g., evaporation). In many cases, except where zero liquid waste is required, membrane-based desalination employing RO is chosen as a cost-effective solution for freshwater recovery and minimization of liquid waste volumes.

### SUMMARY

The present disclosure provides a membrane-based process capable of concentrating industrial wastewater or reverse osmosis (RO) reject to total dissolved solids concentrations exceeding 100,000 mg/L through coordinated control of ultra-high pressure operation, constrained membrane flux, and chemical conditioning including both a scale inhibitor and a surfactant. It has been discovered that this combination enables stable operation at osmotic pressures beyond conventional reverse osmosis limits. The disclosed process thereby enables membrane-based brine concentration previously achievable only through thermal processes.

In a first implementation, a method for concentrating an industrial wastewater or reverse osmosis (RO) reject stream using a membrane-based process, comprising: introducing a feed stream comprising dissolved salts into an ultra-high pressure reverse osmosis (UHPRO) membrane system; operating, as an operating pressure, the UHPRO membrane system at an elevated feed pressure; maintaining average membrane flux between 2.0 and 6.0 gallons per square foot per day and a lead element flux not exceeding 10 gallons per square foot per day; conditioning the feed stream by adding at least one scale inhibitor and at least one surfactant configured to modify interfacial interactions between dissolved species and a membrane surface of the UHPRO membrane system, wherein the surfactant is present at a concentration effective to reduce surface tension and inhibit nucleation and deposition of sparingly soluble salts and foulants on the membrane surface, wherein stable operation is achieved only when the operating pressure, membrane flux, and chemical conditioning are concurrently maintained within specified ranges, wherein stable operation comprises: (i) a normalized permeate flux decline of less than 10% over at least 5-7 days of continuous operation; and (ii) absence of irreversible membrane scaling requiring membrane replacement; and recovering a concentrate stream having a total dissolved solids (TDS) concentration of at least 100,000 mg/L.

In a second implementation, a method for concentrating an industrial wastewater or reverse osmosis (RO) reject stream using a membrane-based process wherein a feed stream is pretreated to reduce suspended solids and hardness prior to an ultra-high pressure reverse osmosis (UHPRO) membrane system, comprising: receiving an industrial wastewater or RO reject stream that contains suspended solids and dissolved salts; directing the industrial wastewater or RO reject stream to a pretreatment step, comprising: i. pre-treating, as pretreated water, the industrial wastewater or RO reject to reduce concentration of suspended solids and/or total hardness to generate an effluent that contains low levels of total hardness; ii. in reducing suspended solids and/or hardness and generating an effluent that contains low levels of total hardness, also generating a pretreatment waste stream that contains removed suspended solids and/or hardness; and iii. directing the pretreatment waste stream, containing the removed suspended solids and/or hardness, to waste for disposal; after suspended solids and/or hardness removal, introducing a feed stream comprising dissolved salts into a UHPRO membrane system; operating, as an operating pressure, the UHPRO membrane system at an elevated feed pressure; maintaining average membrane flux between 2.0 and 6.0 gallons per square foot per day and a lead element flux not exceeding 10 gallons per square foot per day; conditioning the feed stream by adding at least one scale inhibitor and at least one surfactant configured to modify interfacial interactions between dissolved species and a membrane surface of the UHPRO membrane system, wherein the at least one surfactant is present at a concentration effective to reduce surface tension and inhibit nucleation and deposition of sparingly soluble salts and foulants on the membrane surface, wherein stable operation is achieved only when the operating pressure, membrane flux, and chemical conditioning are concurrently maintained within specified ranges, wherein stable operation comprises: (i) a normalized permeate flux decline of less than 10% over at least 5-7 days of continuous operation, and (ii) absence of irreversible membrane scaling requiring membrane replacement; and recovering a concentrate stream having a total dissolved solids (TDS) concentration of at least 100,000 mg/L.

In a third implementation, a system for concentrating an industrial wastewater or reverse osmosis reject stream, comprising: an ultra-high pressure reverse osmosis (UHPRO) membrane system configured to operate at an elevated feed pressure as an operating pressure; a dosing system configured to introduce at least one scale inhibitor and at least one surfactant into a feed stream; and a control system configured to: (i) regulate feed pressure, (ii) control average membrane flux with a range of 2.0 and 6.0 gallons per square foot per day, and (iii) coordinate dosing of the scale inhibitor and surfactant in response to feedwater composition, wherein the control system maintains concurrent control of the operating pressure, flux, and chemical conditioning to achieve stable operation at total dissolved solids concentrations of at least 100,000 mg/L.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a table illustrating an example characterization of constituent parameters for an industrial wastewater (or reverse osmosis (RO) reject waste stream), an ultra-high pressure RO (UHPRO) concentrate, a UHPRO permeate, and treated water, according to an implementation of the present disclosure.

FIG. 2 is a system diagram illustrating a treatment process for utilizing a UHPRO membrane system to treat industrial wastewater or RO reject waste stream, according to an implementation of the present disclosure.

FIG. 3 is a system diagram illustrating a treatment process for utilizing a UHPRO membrane system to treat industrial wastewater or RO reject waste stream and including pretreatment suspended solids and/or hardness removal, according to an implementation of the present disclosure.

FIG. 4 is a flowchart illustrating an example of a method for utilization of an ultra-high pressure reverse osmosis (UHPRO) membrane system to treat industrial wastewater or a RO reject waste stream, according to an implementation of the present disclosure.

FIG. 5 is a table comparing different modes of membrane operation at high pressure and illustrating that the disclosed process(es) provides stable operation not otherwise achieved, according to an implementation of the present disclosure.

FIG. 6 is a table illustrating UHPRO pilot performance in terms of salt rejection and permeate water quality, according to an implementation of the present disclosure.

FIG. 7 is a table illustrating UHPRO pilot performance in terms of system recovery, flux rates, and operating pressures, according to an implementation of the present disclosure.

Like reference numbers and designations in the various drawings indicate like elements.

### DETAILED DESCRIPTION

The following detailed description describes utilization of an ultra-high pressure reverse osmosis (UHPRO) membrane system to treat industrial wastewater or a RO reject waste stream and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Due to challenges associated with disposal of brine generated in industrial wastewater treatment processes, there is a need to develop reliable and alternate treatment processes to minimize liquid waste volumes that require disposal (e.g., by injection). At the same time, there is an increased interest in recovering industrial wastewater to generate freshwater (or “water”) for beneficial reuse. Beneficial reuse applications could include, but are not limited to, irrigation and agricultural water, aquifer replenishment, industrial use, and freshwater to support oil and gas exploration and production operations.

Economic feasibility and sustainability goals of industrial wastewater treatment processes are often impacted by maximizing a volume of freshwater generated and minimizing liquid waste volumes that require disposal. Two common desalination methods for treating industrial wastewater to maximize freshwater and minimize liquid waste involve membrane-based treatment with reverse osmosis (RO) or thermal treatment techniques (e.g., evaporation). In many cases, except where zero liquid waste is required, membrane-based desalination employing RO is chosen as a cost-effective solution for freshwater recovery and minimization of liquid waste volumes.

Traditionally, brine generated in a 1,000-1,200 psi seawater RO system operating at a maximum water recovery will have a maximum total dissolved solids (TDS) concentration in the range of 70,000-80,000 mg/L due to pressure limitations. Conventional reverse osmosis systems are constrained by osmotic pressure and scaling limitations that prevent operation at total dissolved solids concentrations exceeding approximately 80,000 mg/L. This limits the achievable freshwater recovery of RO processes. In order to further increase recovery of water that is suitable for beneficial reuse and to reduce liquid waste volumes, the TDS concentration in the liquid brine will increase, which would exceed osmotic pressure limits of conventional RO systems. Attempts to increase recovery beyond this threshold with conventional RO systems typically results in rapid membrane fouling, scaling, or loss of flux stability.

Increasing operating pressure alone does not overcome these limitations. At elevated pressures, concentration polarization and scaling accelerate, leading to unstable operation and reduced membrane life. Similarly, operation at elevated membrane flux increases localized supersaturation at the membrane surface, further exacerbating scaling and fouling. Accordingly prior processes have not enabled stable membrane-based concentration to total dissolved solids concentrations exceeding approximately 80,000 mg/L without reliance on thermal processes.

In this case, thermal treatment technologies (e.g., evaporation) are often resorted to as a proven technology process for brine concentration/minimization of brine streams. However, capital and operating costs associated with thermal treatment may be substantial and cost-prohibitive, often causing brine minimization projects to not progress past planning stages.

Until recently, RO operating pressures were limited (e.g., 1,200 psi (80 bar)) due to materials used to manufacture the RO membranes. As previously described, this limits the achievable freshwater recovery of RO processes. However, recent advancements in RO membrane manufacturing now permits RO membranes to be operated at ultra-high pressures (e.g., 1,200 psi up to and including 1,800 psi (120 bar)).

According to the present disclosure, a UHPRO system is operated at an “elevated feed pressure.” As used herein, “elevated feed pressure” refers to a feed pressure applied to the membrane system that is greater than pressures typically used in conventional reverse osmosis systems and that is sufficient to enable permeate flux under high salinity conditions.

In some implementations, the elevated feed pressure is greater than 1,100 psi. In some implementations, the elevated feed pressure is greater than 1,200 psi. In some implementations, the elevated feed pressure is between approximately 1,200 psi and 1,800 psi.

In some implementations, the elevated feed pressure exceeds an osmotic pressure of the feed stream by at least 10%, and in some cases by approximately 10% to 30%. In other implementations, the elevated feed pressure exceeds the osmotic pressure by up to approximately 30% to 60%.

In some implementations, the elevated feed pressure is selected to enable treatment of feed streams having total dissolved solids (TDS) concentrations greater than 50,000 mg/L, and in some cases greater than 100,000 mg/L.

The elevated feed pressure, in combination with controlled membrane flux and chemical conditioning, enables stable operation under high salinity conditions.

It has been discovered that with a constrained flux range, in combination with ultra-high pressure and concurrent addition of both a scale inhibitor and a surfactant, enables sustained membrane operation at osmotic pressures previously considered impractical for membrane systems. This operating regime is not a predictable extension of conventional reverse osmosis design, as increasing pressure alone does not yield stable operation due to scaling and fouling constraints. Deviation from any one of these parameters results in rapid scaling, fouling, or loss of flux stability. The disclosed combination produces a synergistic effect that is not predictable from the individual contributions of pressure, flux control, or chemical conditioning, and it enables membrane-based concentration to total dissolved levels exceeding 100,000 mg/L without reliance on thermal evaporation, representing a departure from conventional brine management processes.

Described is a treatment process that includes a UHPRO membrane system operating withing a defined flux range with necessary conditioning chemicals/pretreatment and post-treatment to further concentrate an industrial wastewater or RO reject waste stream. Flux is membrane throughput. Average membrane flux refers to permeate flow rate normalized by the total active membrane area of the membrane system. The described process is based on a defined average membrane flux range (e.g., 2.0-6.0 gallons per square foot per day) (gfd) and a maximum lead element flux rate of up to 10.0 gfd to maximize recovery while maintaining sufficient crossflow velocity and staying within pressure limitations of the membrane system. Operation above the maximum lead element flux rate of 10.0 gallons per square foot per day results in increased concentration polarization at the membrane surface, leading to localized supersaturation and rapid scale formation. Conversely, operation below approximately 2.0 gfd as an average membrane flux rate reduces crossflow velocity and increases residence time at the membrane surface, which can also promote scaling and reduce overall system productivity. Operating the system within the average membrane flux range of 2.0-6.0 gfd is also critical to control osmotic pressure while maximizing recovery. Accordingly, the defined flux range is a critical operating constraint for achieving stable and optimal performance.

Stable operation is achieved only when pressure, membrane flux, and chemical conditioning are simultaneously controlled within the ranges described herein. Operation outside of these ranges results in rapid fouling, scaling, or loss of productivity.
a. Normalized permeate flux decline is less than 10% over a period of at least 5-7 days of continuous operation,
b. Permeability loss attributable to scaling or fouling does not exceed 15% prior to cleaning, and
c. No irreversible scaling is observed requiring membrane replacement

These criteria distinguish the disclosed operating regime from conventional high-pressure RO operation, which exhibits rapid flux decline and instability under comparable salinity conditions in the presence of scale formers and foulants.

Freshwater volumes suitable for beneficial reuse are increased while liquid waste volumes requiring disposal are substantially reduced.

Reduced capital investment compared to a thermal treatment process. A thermal treatment process (e.g., evaporation) would require a minimum of 4-5 times the capital investment compared to the described process to achieve the same quantity of treated water suitable for beneficial reuse.

Reduced power consumption compared to a thermal treatment process. A thermal treatment process (e.g., evaporation) would require a minimum of 4-5 times the energy consumption compared to the described process to achieve the same quantity of treated water suitable for beneficial reuse.

The described process can be applied as a “bolt-on”/minimal required footprint solution to minimize brine from existing treatment facilities.

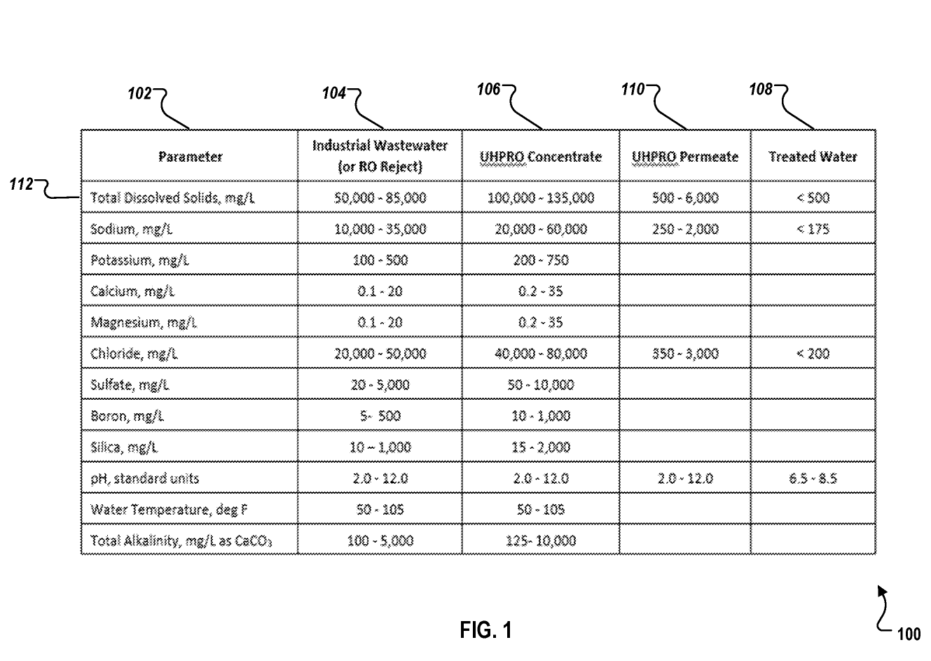

Turning to FIG. 1, FIG. 1 is a table 100 illustrating an example characterization of constituent parameters 102 for an industrial wastewater (or RO reject waste stream) 104, an UHPRO concentrate 106, a UHPRO permeate 110, and treated water 108, according to an implementation of the present disclosure.

As an example, values for Total Dissolved Solids (TDS) 112 will be discussed with respect to the described process. In some implementations, TDS 112 at levels of 50,000-85,000 mg/L in industrial wastewater (or RO reject) 104 (serving as in influent to the described process) would result in a UHPRO concentrate 106 (i.e., a brine) with TDS levels of 100,000-135,000 mg/L, a UHPRO permeate 110 with TDS levels of 500-6,000 and treated water 108 with TDS levels of less than 500 mg/L.

As will be understood by those of ordinary skill in the art, data illustrated in FIG. 1 is only one example of a range of values for constituent parameters 102 in an industrial wastewater (or RO reject waste stream) 104, UHPRO concentrate 106, UHPRO permeate 110, and treated water 108. The described process is not limited to these specific water quality ranges, and it should be understood that concentrations of contaminants can vary for each application.

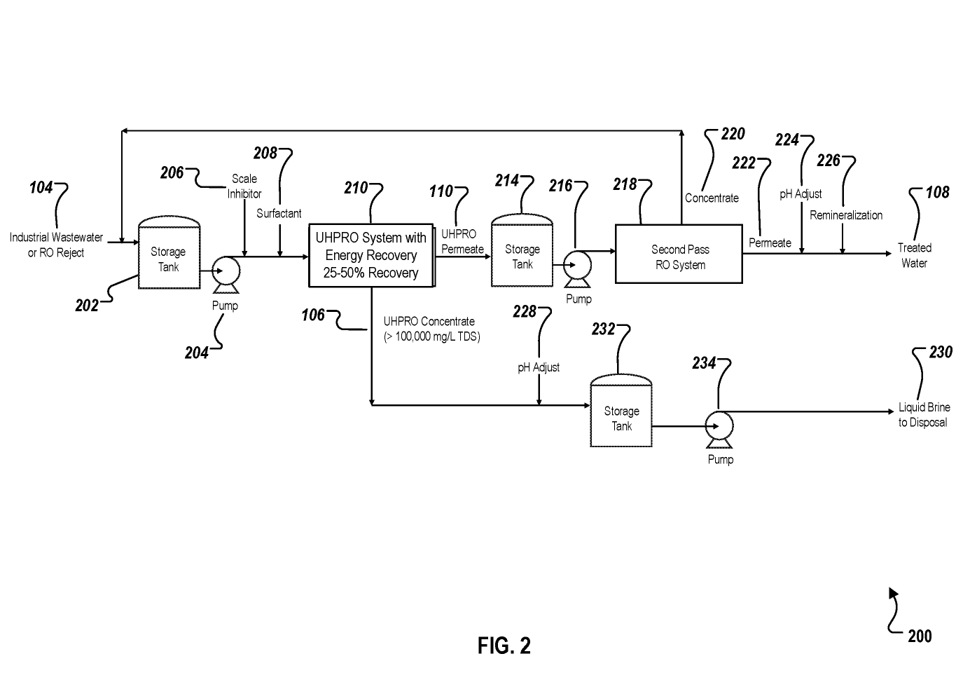

FIG. 2 is a system diagram illustrating a treatment process 200 for utilizing a UHPRO membrane system to treat industrial wastewater or RO reject waste stream, according to an implementation of the present disclosure.

In FIG. 2, an industrial wastewater or RO reject waste stream 104 (or “brine”) is received by a storage tank 202. In FIG. 2, for example, the industrial wastewater or RO reject waste stream 104 can contain dissolved ions of sodium, chloride, calcium, magnesium, and silica.

The industrial wastewater or RO reject waste stream 104 is pressurized by a pump 204 followed by the addition of a scale inhibitor 206 and/or a surfactant 208, which may be added prior to UHPRO membranes to control scaling and/or fouling across a UHPRO membrane system 210.

The pressurized water is fed to the UHPRO membrane system 210. The UHPRO membrane system 210 generally comprises a high pressure booster pump, pressure vessels, UHPRO membranes, and energy recovery to optimize energy consumption (not all illustrated). The disclosed process enables membrane-based concentration at energy consumption levels significantly lower than thermal evaporation systems, which is not achievable using conventional RO at comparable salinity. In some implementations, the UHPRO membrane system 210 is operated at an average membrane flux rate of 2.0-6.0 gfd and a lead element flux rate of up to 10.0 gfd to maximize water recovery while providing sufficient crossflow velocity to mitigate fouling and concentration polarization. In some implementations, the applied operating pressure of the UHPRO membrane system exceeds the osmotic pressure of the feed stream by at least approximately 10% to 30%. Maintaining this pressure differential enables sustained permeate flux under elevated salinity conditions while avoiding instability associated with excessive pressure or insufficient driving force. The defined pressure relationship, in combination with the constrained flux range and chemical conditioning, is critical to achieving stable operation at high total dissolved solids concentrations. In some implementations, the UHPRO membrane system 210 is operated within a range of 25-50% water recovery, generating a UHPRO permeate 110 and a UHPRO concentrate 106 (e.g. > 100,000 mg/L TDS).

The UHPRO permeate 110 is stored in a storage tank 214. The UHPRO permeate 110 in the storage tank 214 is pressurized using pump 216 and fed into a second pass RO system 218 for treatment/reduction of TDS. Concentrate 220 from the second pass RO system 218 is recycled and re-treated (e.g., by entering storage tank 202). Permeate 222 from the second pass RO system 218 can be power of Hydrogen (pH) adjusted with an acid or base/caustic 224 and remineralized with calcium chloride or with another calcium salt 226, as required, to generate treated water 108 that is suitable for beneficial reuse.

From the UHPRO membrane system 210, concentrate 106 can be neutralized (if required) using pH adjustment 228 to liquid brine 230 before being collected in a storage tank 232. The liquid brine 230 can be pressurized from storage tank 232 using pump 234 for disposal.

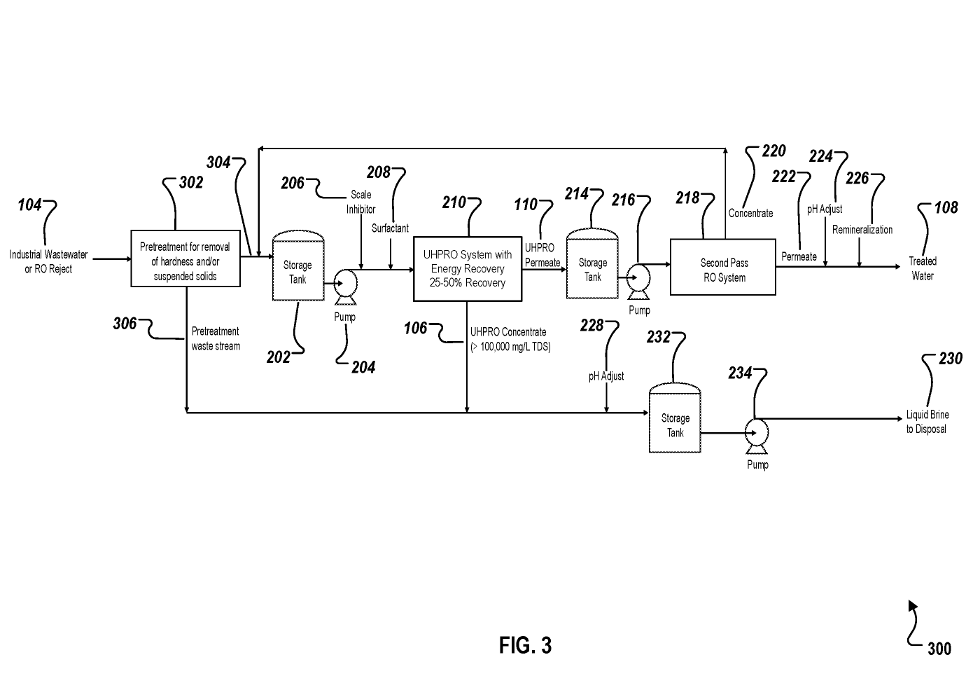

FIG. 3 is a system diagram illustrating a treatment process 300 for utilizing a UHPRO membrane system to treat industrial wastewater or RO reject waste stream and including pretreatment suspended solids and/or hardness removal, according to an implementation of the present disclosure.

In FIG. 3, a pretreatment system 302 is required upstream of the UHPRO membrane system 210 to achieve suspended solids and/or hardness removal to mitigate a potential for fouling and/or scale formation in the UHPRO membrane system 210. The pretreatment system 302 may include filtration and/or ion exchange, or a combination thereof, which reduces a total hardness (e.g., calcium and magnesium ions) and/or total suspended solids to lower levels. Received industrial wastewater or RO reject 104 (containing dissolved ions of sodium, chloride, calcium, magnesium, and/or silica, as well as suspended solids) is directed to a pretreatment step for suspended solids and/or hardness removal. The pretreatment system 302 includes a filtration step to remove suspended solids.

If hardness removal is required to mitigate scaling in the UHPRO membrane system 210, the pretreatment system 302 is configured to generate an effluent 304 that contains low levels of total hardnessfor storage and processing by the UHPRO membrane system 210 (e.g., as previously described in FIG. 2). The pretreatment system also generates a pretreatment waste (purge) stream 306, which may be neutralized (228) as required, and collected in a storage tank 232 prior to disposal (e.g. as previously described in FIG. 2).

Effluent 304 from the pretreatment system 302 is collected in a separate storage tank 202. The pretreatment effluent 304 is pressurized with a pump 204 prior to the addition of a scale inhibitor 206 and/or a surfactant 208, which may be added prior to the UHPRO membranes to control scaling and/or fouling across the UHPRO membrane system 210.

The pressurized water then is fed to the UHPRO membrane system 210. The UHPRO membrane system 210 generally comprises a high pressure booster pump, pressure vessels, UHPRO membranes, and energy recovery to optimize energy consumption (not all illustrated). The UHPRO membrane system 210 is operated at an average membrane flux rate of 2.0-6.0 gfd and a lead element flux rate of up to 10.0 gfd to maximize water recovery while providing sufficient crossflow velocity to mitigate fouling and concentration polarization. In some implementations, the UHPRO membrane system 210 is operated at 25-50% water recovery, generating a concentrate 106 and UHPRO permeate 110.

Concentrate 220 from a second pass RO system 218 is recycled and re-treated. Concentrate 106 from the UHPRO, system 210 which exceeds 100,000 mg/L of TDS, is combined with the pretreatment waste (purge) stream 306 and neutralized (228) if required before being collected in a storage tank 232 prior to disposal. The UHPRO permeate 110 is further treated with a second pass of RO (218) for reduction of TDS followed by pH adjustment (224) and remineralization (226), as required, to generate a water 108 that is suitable for beneficial reuse.

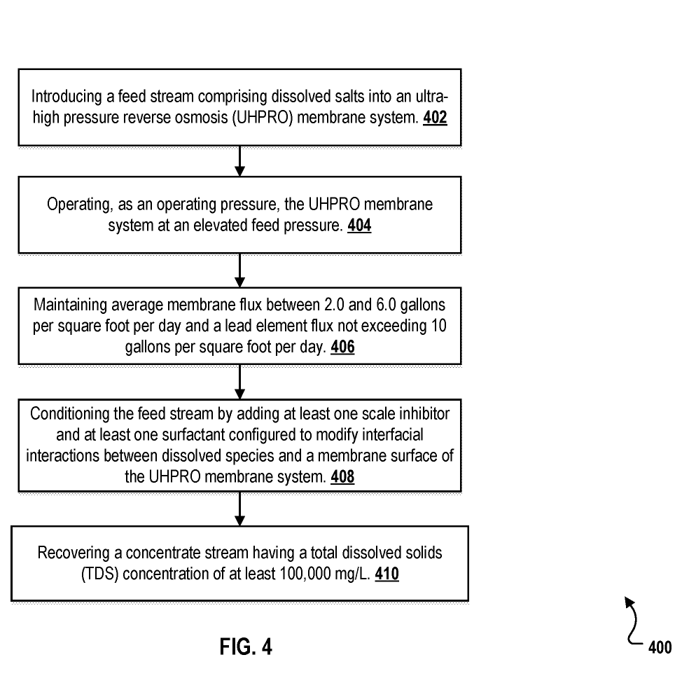

FIG. 4 is a flowchart illustrating an example of a method 400 for utilization of an ultra-high pressure reverse osmosis (RO) membrane system to treat industrial wastewater or a RO reject waste stream, according to an implementation of the present disclosure.

For clarity of presentation, the description that follows generally describes method 400 in the context of the other figures in this description.

At 402, a feed stream comprising dissolved salts is introduced into an ultra-high pressure reverse osmosis (UHPRO) membrane system. From 402, method 400 proceeds to 404.

At 404, the UHPRO membrane system is operated at an elevated feed pressure as an operating pressure.

At 406, average membrane flux is maintained between 2.0 and 6.0 gallons per square foot per day and a lead element flux not exceeding 10 gallons per square foot per day. From 406, method 400 proceeds to 408.

At 408, the feed stream is conditioned by adding at least one scale inhibitor and at least one surfactant configured to modify interfacial interactions between dissolved species and a membrane surface of the UHPRO membrane system. The surfactant is present at a concentration effective to reduce surface tension and inhibit nucleation and deposition of sparingly soluble salts and foulants on the membrane surface. Stable operation is achieved only when the operating pressure, membrane flux, and chemical conditioning are concurrently maintained within specified ranges. Stable operation includes: (i) a normalized permeate flux decline of less than 10% over at least 5-7 days of continuous operation and (ii) absence of irreversible membrane scaling requiring membrane replacement. From 408, method 400 proceeds to 410.

At 410, recovering a concentrate stream having a total dissolved solids (TDS) concentration of at least 100,000 mg/L is recovered. After 410, method 400 can stop.

In some implementations, the at least one surfactant is selected from nonionic, anionic, or amphoteric surfactants; and at least one surfactant is present at a concentration between 1 ppm and 10 ppm.

In some implementations, the at least one scale inhibitor comprises a phosphonate, polymeric antiscalant, or combinations thereof.

In some implementations, the operating pressure exceeds an osmotic pressure of the feed stream by at least 10%.

In some implementations, thermal evaporation is not used.

In some implementations, a permeate stream is treated with a secondary reverse osmosis process.

In some implementations, the UHPRO membrane system includes an energy recovery device to optimize energy consumption and reduce an operating feed pressure requirement for the UHPRO membrane system.

In some implementations, the UHPRO membrane system utilizes ultra-high-pressure seawater reverse osmosis membranes with a minimum salt rejection of 99.7%.

In some implementations, the membrane system operates at a recovery of 25-50%.

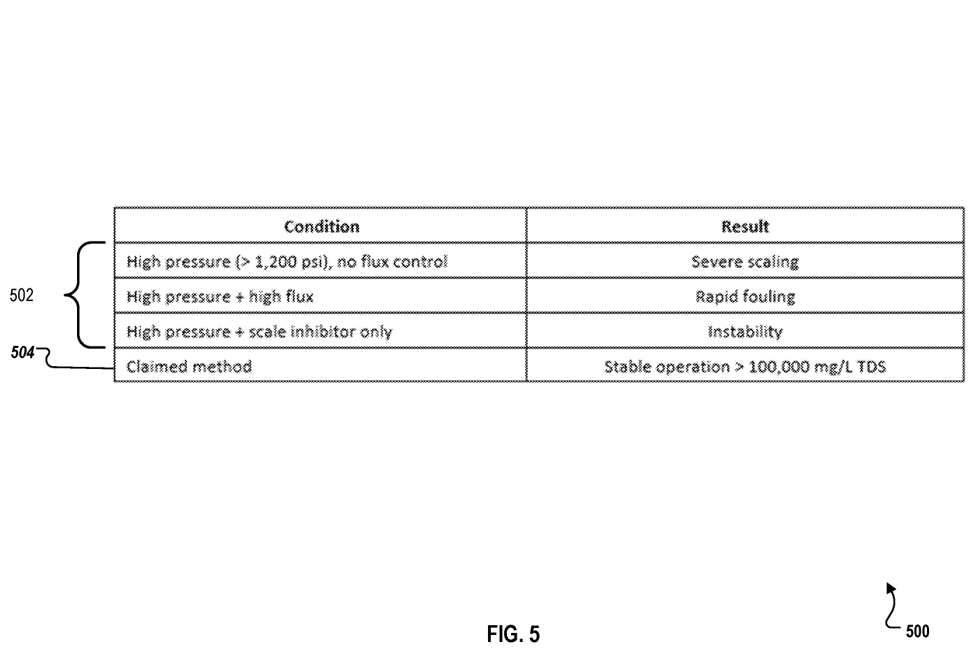

FIG. 5 is a table 500 comparing different modes of membrane operation at high pressure and illustrating that the disclosed process(es) provides stable operation not otherwise achieved, according to an implementation of the present disclosure.

For example, FIG. 5 compares multiple operating modes of membrane treatment at elevated pressure conditions. The data demonstrates that operations using conventional processes 502 – such as increasing pressure without controlling membrane flux or without appropriate chemical conditioning – results in instability, including rapid flux decline, scaling, or reduced performance. In contrast, operations in accordance with the disclosed process at 504, in which pressure, membrane flux, and chemical conditioning are concurrently maintained within the specified ranges, exhibits stable performance at total dissolved solids (TDS) concentrations exceeding 100,000 mg/L. These results confirm that the disclosed combination of operating parameters enables stable operation not achievable through independent adjustment of pressure, flux, or chemistry.

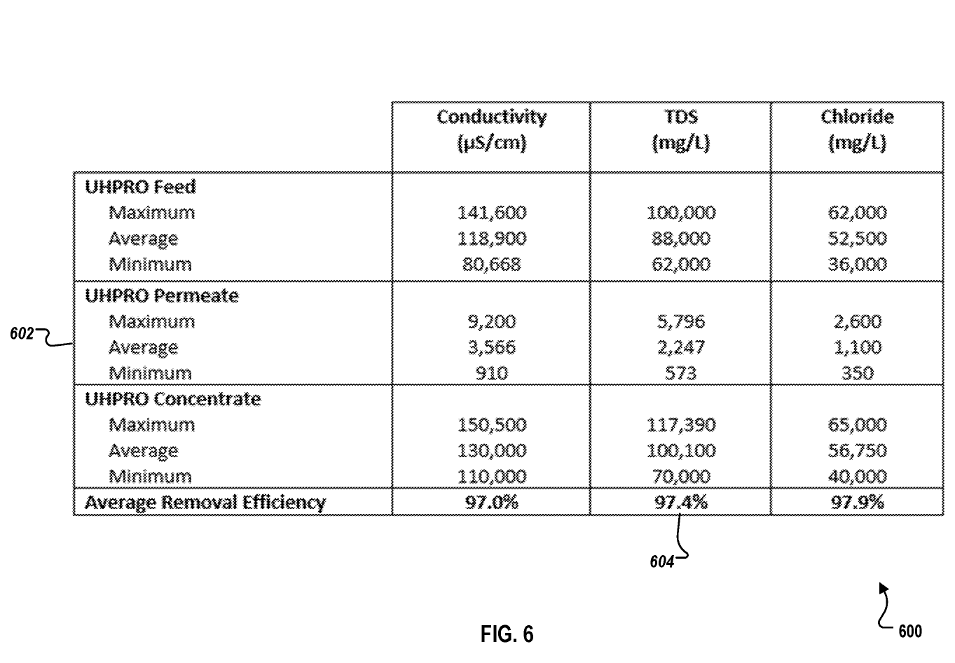

FIG. 6 is a table 600 illustrating UHPRO pilot performance in terms of salt rejection and permeate water quality, according to an implementation of the present disclosure.

For example, FIG. 6 presents pilot performance data illustrating permeate water quality 602 and salt rejection 604 achieved using the disclosed UHPRO process. The data demonstrates that, despite operations at elevated (e.g., “maximum” in table 600) feed salinity levels, high salt rejection is maintained and permeate quality remains suitable for downstream treatment or reuse. These results confirm that the described process enables effective separation performance under conditions where conventional reverse osmosis systems would be expected to exhibit reduced rejection efficiency or instability due to elevated osmotic pressure and scaling potential.

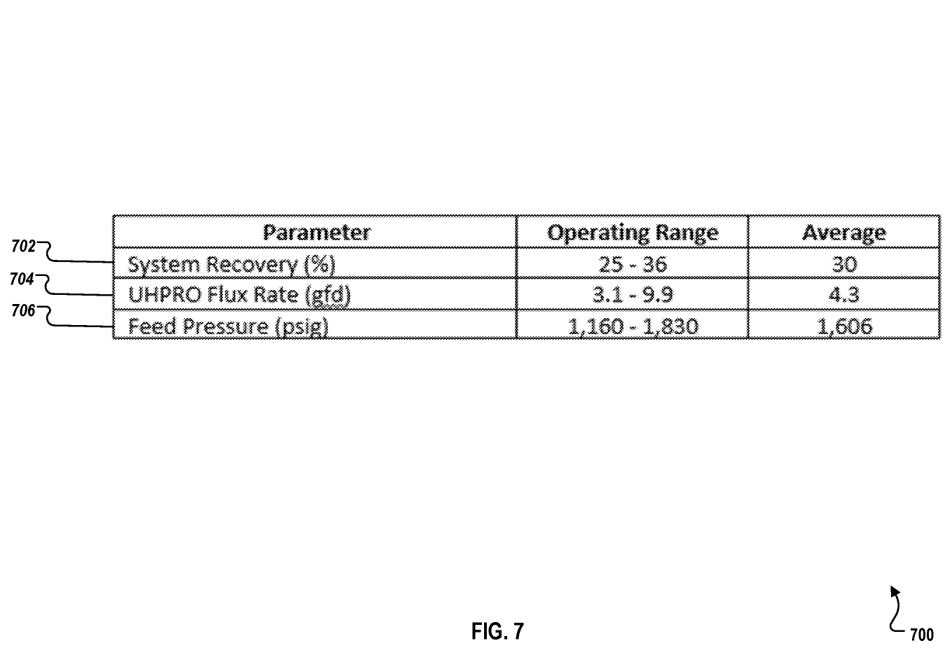

FIG. 7 is a table 700 illustrating UHPRO pilot performance in terms of system recovery, flux rates, and operating pressures, according to an implementation of the present disclosure.

For example, FIG. 7 presents pilot results for system recovery 702, membrane flux 704, and feed/operating pressure 706 under the disclosed UHPRO conditions. The data demonstrate that stable membrane flux and system recovery are maintained while operating at elevated pressures and high total dissolved solids (TDS) concentrations. In conventional reverse osmosis systems, operation at comparable salinity and pressure conditions would be expected to result in rapid flux decline, increase scaling, and reduced system recovery. The ability to maintain stable flux and recovery under these conditions represents an unexpected improvement and confirms that the disclosed combination of pressure, flux constraint, and chemical conditioning produces a synergistic effect not predictable from conventional system designs.

Described implementations of the subject matter can include one or more features, alone or in combination.

For example, in a first implementation, a method for concentrating an industrial wastewater or reverse osmosis (RO) reject stream using a membrane-based process, comprising: introducing a feed stream comprising dissolved salts into an ultra-high pressure reverse osmosis (UHPRO) membrane system; operating, as an operating pressure, the UHPRO membrane system at an elevated feed pressure; maintaining average membrane flux between 2.0 and 6.0 gallons per square foot per day and a lead element flux not exceeding 10 gallons per square foot per day; conditioning the feed stream by adding at least one scale inhibitor and at least one surfactant configured to modify interfacial interactions between dissolved species and a membrane surface of the UHPRO membrane system, wherein the surfactant is present at a concentration effective to reduce surface tension and inhibit nucleation and deposition of sparingly soluble salts and foulants on the membrane surface, wherein stable operation is achieved only when the operating pressure, membrane flux, and chemical conditioning are concurrently maintained within specified ranges, wherein stable operation comprises: (i) a normalized permeate flux decline of less than 10% over at least 5-7 days of continuous operation; and (ii) absence of irreversible membrane scaling requiring membrane replacement; and recovering a concentrate stream having a total dissolved solids (TDS) concentration of at least 100,000 mg/L.

The foregoing and other described implementations can each, optionally, include one or more of the following features:

A first feature, combinable with any of the following features, wherein: the at least one surfactant is selected from nonionic, anionic, or amphoteric surfactants; and the at least one surfactant is present at a concentration between 1 ppm and 10 ppm.

A second feature, combinable with any of the previous or following features, wherein the at least one scale inhibitor comprises a phosphonate, polymeric antiscalant, or combinations thereof.

A third feature, combinable with any of the previous or following features, wherein the operating pressure exceeds an osmotic pressure of the feed stream by at least 10%.

A fourth feature, combinable with any of the previous or following features, wherein thermal evaporation is not used.

A fifth feature, combinable with any of the previous or following features, comprising treating a permeate stream with a secondary reverse osmosis process.

A sixth feature, combinable with any of the previous or following features, wherein the UHPRO membrane system includes an energy recovery device to optimize energy consumption and reduce an operating feed pressure requirement for the UHPRO membrane system.

A seventh feature, combinable with any of the previous or following features, wherein the UHPRO membrane system utilizes ultra-high-pressure seawater reverse osmosis membranes with a minimum salt rejection of 99.7%.

An eighth feature, combinable with any of the previous or following features, wherein the membrane system operates at a recovery of 25-50%.

For example, in a second implementation, a method for concentrating an industrial wastewater or reverse osmosis (RO) reject stream using a membrane-based process wherein a feed stream is pretreated to reduce suspended solids and hardness prior to an ultra-high pressure reverse osmosis (UHPRO) membrane system, comprising: receiving an industrial wastewater or RO reject stream that contains suspended solids and dissolved salts; directing the industrial wastewater or RO reject stream to a pretreatment step, comprising: i. pre-treating, as pretreated water, the industrial wastewater or RO reject to reduce concentration of suspended solids and/or total hardness to generate an effluent that contains low levels of total hardness; ii. in reducing suspended solids and/or hardness and generating an effluent that contains low levels of total hardness, also generating a pretreatment waste stream that contains removed suspended solids and/or hardness; and iii. directing the pretreatment waste stream, containing the removed suspended solids and/or hardness, to waste for disposal; after suspended solids and/or hardness removal, introducing a feed stream comprising dissolved salts into a UHPRO membrane system; operating, as an operating pressure, the UHPRO membrane system at an elevated feed pressure; maintaining average membrane flux between 2.0 and 6.0 gallons per square foot per day and a lead element flux not exceeding 10 gallons per square foot per day; conditioning the feed stream by adding at least one scale inhibitor and at least one surfactant configured to modify interfacial interactions between dissolved species and a membrane surface of the UHPRO membrane system, wherein the at least one surfactant is present at a concentration effective to reduce surface tension and inhibit nucleation and deposition of sparingly soluble salts and foulants on the membrane surface, wherein stable operation is achieved only when the operating pressure, membrane flux, and chemical conditioning are concurrently maintained within specified ranges, wherein stable operation comprises: (i) a normalized permeate flux decline of less than 10% over at least 5-7 days of continuous operation, and (ii) absence of irreversible membrane scaling requiring membrane replacement; and recovering a concentrate stream having a total dissolved solids (TDS) concentration of at least 100,000 mg/L.

A first feature, combinable with any of the previous or following features, wherein: the at least one surfactant is selected from nonionic, anionic, or amphoteric surfactants; and the at least one surfactant is present at a concentration between 1 ppm and 10 ppm.

A second feature, combinable with any of the previous or following features, wherein the at least one scale inhibitor comprises a phosphonate, polymeric antiscalant, or combinations thereof.

A third feature, combinable with any of the previous or following features, wherein the operating pressure exceeds an osmotic pressure of the feed stream by at least 10%.

wherein the method is performed without use of thermal evaporation.

A fifth feature, combinable with any of the previous or following features, comprising treating a permeate stream with a secondary reverse osmosis process.

A sixth feature, combinable with any of the previous or following features, wherein the UHPRO membrane system includes an energy recovery device to optimize energy consumption and reduce an operating feed pressure requirement for the UHPRO membrane system.

A seventh feature, combinable with any of the previous or following features, wherein the UHPRO membrane system utilizes ultra-high-pressure seawater reverse osmosis membranes with a minimum salt rejection of 99.7%.

An eighth feature, combinable with any of the previous or following features, wherein the membrane system operates at a recovery of 25-50%.

For example, in a third implementation, a system for concentrating an industrial wastewater or reverse osmosis reject stream, comprising: an ultra-high pressure reverse osmosis (UHPRO) membrane system configured to operate at an elevated feed pressure as an operating pressure; a dosing system configured to introduce at least one scale inhibitor and at least one surfactant into a feed stream; and a control system configured to: (i) regulate feed pressure, (ii) control average membrane flux with a range of 2.0 and 6.0 gallons per square foot per day, and (iii) coordinate dosing of the scale inhibitor and surfactant in response to feedwater composition, wherein the control system maintains concurrent control of the operating pressure, flux, and chemical conditioning to achieve stable operation at total dissolved solids concentrations of at least 100,000 mg/L.

A first feature, combinable with any of the previous or following features, comprising: a secondary reverse osmosis system configured to treat permeate; or a pretreatment system configured to remove suspended solids or hardness.

While this specification contains many particular implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some implementations, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations, steps, or actions are depicted in the drawings or claims in a particular order, this should not be understood as requiring that such operations, steps, or actions be performed in the particular order shown or in sequential order, or that all illustrated operations, steps, or actions be performed (some operations, steps, or actions can be considered optional), to achieve desirable results. In certain circumstances, operations, steps, or actions may be performed simultaneously.

The separation or integration of various components and/or system modules in the previously described implementations should not be understood as requiring such separation or integration in all implementations. In some implementations, described components can be integrated together in a single component or separated into multiple components.

Accordingly, the previously described example implementations do not define or constrain the present disclosure. Other changes, substitutions, and alterations are also possible without departing from the scope of the present disclosure.

What is claimed is:

1. A method for concentrating an industrial wastewater or reverse osmosis (RO) reject stream using a membrane-based process, comprising:
introducing a feed stream comprising dissolved salts into an ultra-high pressure reverse osmosis (UHPRO) membrane system;
operating, as an operating pressure, the UHPRO membrane system at an elevated feed pressure;
maintaining average membrane flux between 2.0 and 6.0 gallons per square foot per day and a lead element flux not exceeding 10 gallons per square foot per day;
conditioning the feed stream by adding at least one scale inhibitor and at least one surfactant configured to modify interfacial interactions between dissolved species and a membrane surface of the UHPRO membrane system,
wherein the surfactant is present at a concentration effective to reduce surface tension and inhibit nucleation and deposition of sparingly soluble salts and foulants on the membrane surface,
wherein stable operation is achieved only when the operating pressure, membrane flux, and chemical conditioning are concurrently maintained within specified ranges,
wherein stable operation comprises:
(i) a normalized permeate flux decline of less than 10% over at least 5-7 days of continuous operation; and
(ii) absence of irreversible membrane scaling requiring membrane replacement; and
recovering a concentrate stream having a total dissolved solids (TDS) concentration of at least 100,000 mg/L.

2. The method of claim 1, wherein:
the at least one surfactant is selected from nonionic, anionic, or amphoteric surfactants; and
the at least one surfactant is present at a concentration between 1 ppm and 10 ppm.

3. The method of claim 1, wherein the at least one scale inhibitor comprises a phosphonate, polymeric antiscalant, or combinations thereof.

4. The method of claim 1, wherein the operating pressure exceeds an osmotic pressure of the feed stream by at least 10%.

5. The method of claim 1, wherein thermal evaporation is not used.

6. The method of claim 1, comprising treating a permeate stream with a secondary reverse osmosis process.

7. The method of claim 1, wherein the UHPRO membrane system includes an energy recovery device to optimize energy consumption and reduce an operating feed pressure requirement for the UHPRO membrane system.

8. The method of claim 1, wherein the UHPRO membrane system utilizes ultra-high-pressure seawater reverse osmosis membranes with a minimum salt rejection of 99.7%.

9. The method of claim 1, wherein the membrane system operates at a recovery of 25-50%.

10. A method for concentrating an industrial wastewater or reverse osmosis (RO) reject stream using a membrane-based process wherein a feed stream is pretreated to reduce suspended solids and hardness prior to an ultra-high pressure reverse osmosis (UHPRO) membrane system, comprising:
receiving an industrial wastewater or RO reject stream that contains suspended solids and dissolved salts;
directing the industrial wastewater or RO reject stream to a pretreatment step, comprising:
10i. pre-treating, as pretreated water, the industrial wastewater or RO reject to reduce concentration of suspended solids and/or total hardness to generate an effluent that contains low levels of total hardness;
10ii. in reducing suspended solids and/or hardness and generating an effluent that contains low levels of total hardness, also generating a pretreatment waste stream that contains removed suspended solids and/or hardness; and
10iii. directing the pretreatment waste stream, containing the removed suspended solids and/or hardness, to waste for disposal;
after suspended solids and/or hardness removal, introducing a feed stream comprising dissolved salts into a UHPRO membrane system;
operating, as an operating pressure, the UHPRO membrane system at an elevated feed pressure;
maintaining average membrane flux between 2.0 and 6.0 gallons per square foot per day and a lead element flux not exceeding 10 gallons per square foot per day;
conditioning the feed stream by adding at least one scale inhibitor and at least one surfactant configured to modify interfacial interactions between dissolved species and a membrane surface of the UHPRO membrane system,
wherein the at least one surfactant is present at a concentration effective to reduce surface tension and inhibit nucleation and deposition of sparingly soluble salts and foulants on the membrane surface,
wherein stable operation is achieved only when the operating pressure, membrane flux, and chemical conditioning are concurrently maintained within specified ranges,
wherein stable operation comprises:
(i) a normalized permeate flux decline of less than 10% over at least 5-7 days of continuous operation, and
(ii) absence of irreversible membrane scaling requiring membrane replacement; and
recovering a concentrate stream having a total dissolved solids (TDS) concentration of at least 100,000 mg/L.

11. The method of claim 10, wherein:
the at least one surfactant is selected from nonionic, anionic, or amphoteric surfactants; and
the at least one surfactant is present at a concentration between 1 ppm and 10 ppm.

12. The method of claim 10, wherein the at least one scale inhibitor comprises a phosphonate, polymeric antiscalant, or combinations thereof.

13. The method of claim 10, wherein the operating pressure exceeds an osmotic pressure of the feed stream by at least 10%.

14. The method of claim 10, wherein the method is performed without use of thermal evaporation.

15. The method of claim 10, comprising treating a permeate stream with a secondary reverse osmosis process.

16. The method of claim 10, wherein the UHPRO membrane system includes an energy recovery device to optimize energy consumption and reduce an operating feed pressure requirement for the UHPRO membrane system.

17. The method of claim 10, wherein the UHPRO membrane system utilizes ultra-high-pressure seawater reverse osmosis membranes with a minimum salt rejection of 99.7%.

18. The method of claim 10, wherein the membrane system operates at a recovery of 25-50%.

19. A system for concentrating an industrial wastewater or reverse osmosis reject stream, comprising:
an ultra-high pressure reverse osmosis (UHPRO) membrane system configured to operate at an elevated feed pressure as an operating pressure;
a dosing system configured to introduce at least one scale inhibitor and at least one surfactant into a feed stream; and
a control system configured to:
(i) regulate feed pressure,
(ii) control average membrane flux with a range of 2.0 and 6.0 gallons per square foot per day, and
(iii) coordinate dosing of the scale inhibitor and surfactant in response to feedwater composition,
wherein the control system maintains concurrent control of the operating pressure, flux, and chemical conditioning to achieve stable operation at total dissolved solids concentrations of at least 100,000 mg/L.

20. The system of claim 19, comprising:
a secondary reverse osmosis system configured to treat permeate; or
a pretreatment system configured to remove suspended solids or hardness.
